(19) United States
(12) Patent Application Publication
(10) Pub. No.: US 2026/0149138 A1
(43) Pub. Date: May 28, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventors: Su Hyeon KANG, Yongin-si (KR); Chan Hyung LEE, Yongin-si (KR); Byeong Gwan LEE, Yongin-si (KR)

(21) Appl. No.: 19/197,263

(22) Filed: May 2, 2025

(30) Foreign Application Priority Data
Nov. 25, 2024 (KR) 10-2024-0169680

(51) Int. Cl. H01M 50/538; B60L 50/64; H01M 4/36; H01M 4/62; H01M 10/0587; H01M 50/107; H01M 50/152; H01M 50/533; H01M 50/536

(52) U.S. Cl. CPC H01M 50/538; H01M 4/366; H01M 4/628; H01M 10/0587; H01M 50/107; H01M 50/152; H01M 50/533; H01M 50/536; B60L 50/64; H01M 2220/20

(57) ABSTRACT

An electrode assembly according to the embodiment includes a first electrode, a second electrode, and a separator between the first electrode and the second electrode. The first electrode comprises a first substrate including a first uncoated portion extending upwardly, a first active material layer on the first substrate, and a first protective layer on the first uncoated portion. The second electrode comprises a second substrate including a second uncoated portion extending downwardly, a second active material layer on the second substrate, and a second protective layer on the second uncoated portion. The first protective layer and the second protective layer are disposed on the first active material layer, the second active material layer, and the separator.

### CROSS-REFERENCE TO THE RELATED APPLICATION

The present application claims priority to and the benefit of Korean Patent Application No. 10-2024-0169680, filed on Nov. 25, 2024, in the Korean Intellectual Property Office, the entire disclosure of which is incorporated herein by reference.

### BACKGROUND

### 1. Field

Embodiments relate to an electrode assembly and a secondary battery including the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery with improved capacity.

Embodiments provide a secondary battery that may be easily manufactured.

The electrode assembly according to the embodiment includes a first electrode, a second electrode, and a separator between the first electrode and the second electrode, the first electrode comprises a first substrate comprising a first uncoated portion extending upwardly, a first active material layer on the first substrate, and a first protective layer on the first uncoated portion, the second electrode comprises a second substrate comprising a second uncoated portion extending downwardly, a second active material layer on the second substrate, and a second protective layer on the second uncoated portion, and the first protective layer and the second protective layer are disposed on the first active material layer, the second active material layer, and the separator.

The first protective layer covers an entirety of the first active material layer, and the second protective layer covers an entirety of the second active material layer.

The first protective layer is spaced apart from the first active material layer, and the second protective layer is spaced apart from the second active material layer.

The first protective layer is in contact with the first active material layer, and the second protective layer is in contact with the second active material layer.

The thicknesses of the first protective layer and the thickness of the second protective layer are less than or equal to the sum of the thicknesses of the first active material layer, the second active material layer, and the separator.

The first protective layer and the second protective layer comprise a non-conductive material.

The first protective layer and the second protective layer comprise a magnetic material.

The first protective layer and the second protective layer comprise a plurality of patterns spaced apart from each other, the electrode assembly is wound, and a length and an interval of the patterns increase from a start of the winding of the electrode assembly to an end of the winding of the electrode assembly.

The electrode assembly comprises a welding region and a non-welding region, and the patterns are disposed in the welding region.

The welding region comprises a first welding region and a second welding region facing each other, a first-first protective layer and a second-first protective layer are respectively disposed on the upper and lower portions of the first welding region, a first-second protective layer and a second-second protective layer are respectively disposed on the upper and lower portions of the second welding region, and at least one of the first-first protective layer, the first-second protective layer, the second-first protective layer, or the second-second protective layer has a polarity that is different from another of the first-first protective layer, the first-second protective layer, the second-first protective layer, or the second-second protective layer.

The first-first protective layer and the first-second protective layer have different polarities, and the second-first protective layer and the second-second protective layer have different polarities.

The first-first protective layer and the second-first protective layer have the same polarity, and the first-second protective layer and the second-second protective layer have the same polarity.

At least one of the first protective layer or the second protective layer comprises a protrusion.

The electrode assembly according to the embodiment includes a first electrode, a second electrode, and a separator between the first electrode and the second electrode, the first electrode comprises a first substrate comprising a first uncoated portion extending upwardly, a first active material layer on the first substrate, and a first reinforcing part on the first uncoated portion, the second electrode comprises a second substrate comprising a second uncoated portion extending downwardly, a second active material layer on the second substrate, and a second reinforcing part on the second uncoated portion, the first reinforcing part and the second reinforcing part are disposed on the first active material layer, the second active material layer, and the separator, the first reinforcing part and the first substrate are formed from the same material, and the second reinforcing part and the second substrate are formed from the same material.

The length of the first reinforcing part is 95% to 105% of the length of the first uncoated portion, and the length of the second reinforcing part is 95% to 105% of the length of the second uncoated portion.

The electrode assembly further comprises a first protective layer on the first reinforcing part; and a second protective layer on the second reinforcing part.

The first protective layer is disposed on the second active material layer and the separator, and the second protective layer is disposed on the first active material layer and the separator.

The electrode assembly further comprises a first protective layer on the first uncoated portion; and a second protective layer on the second uncoated portion, the first reinforcing part and the first protective layer are disposed on the same surface of the first uncoated portion, and the second reinforcing part and the second protective layer are disposed on the same surface of the second uncoated portion.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIGS. 1 and 2 are perspective views showing a secondary battery according to an embodiment.

FIG. 3 is a cross-sectional view taken along a region A-A′ of FIG. 1.

FIG. 4 is a top view showing the secondary battery according to the embodiment after winding.

FIG. 5 is a plan view showing a first electrode according to the embodiment before winding.

FIG. 6 is a cross-sectional view taken along a region C-C′ of FIG. 5.

FIG. 7 is a plan view showing a second electrode according to the embodiment before winding.

FIG. 8 is a cross-sectional view taken along a region D-D′ of FIG. 7.

FIG. 9 is a cross-sectional view taken along a region B-B′ of FIG. 4.

FIG. 10 is a top view showing the secondary battery according to another embodiment after winding.

FIG. 11 is a plan view showing the first electrode according to another embodiment before winding.

FIG. 12 is a cross-sectional view taken along a region E-E′ of FIG. 10.

FIG. 13 is a cross-sectional view taken along a region F-F′ of FIG. 10.

FIG. 14 is a plan view showing the first electrode according to another embodiment before winding.

FIG. 15 is a cross-sectional view taken along a region G-G′ of FIG. 14.

FIG. 16 is another cross-sectional view taken along a region B-B′ of FIG. 4.

FIG. 17 is a plan view showing the first electrode according to another embodiment before winding.

FIG. 18 is a cross-sectional view taken along a region H-H′ of FIG. 17.

FIG. 19 is another cross-sectional view taken along a region B-B′ of FIG. 4.

FIG. 20 is another cross-sectional view taken along a region H-H′ of FIG. 17.

FIG. 21 is another cross-sectional view taken along a region B-B′ of FIG. 4.

FIG. 22 is a perspective view of a battery module including secondary batteries according to an embodiment.

FIGS. 23 and 24 are perspective views showing a battery pack including battery modules according to embodiments.

FIGS. 25 and 26 are perspective views and a side view showing a vehicle including battery packs according to embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the following description, the width (direction of diameter) of the case is defined as the X direction, and the direction of height of the case is defined as the Y direction.

Hereinafter, secondary batteries according to embodiments will be described with reference to the drawings.

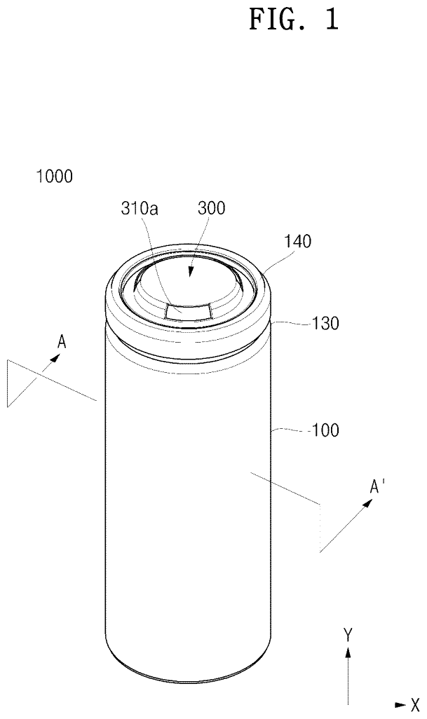

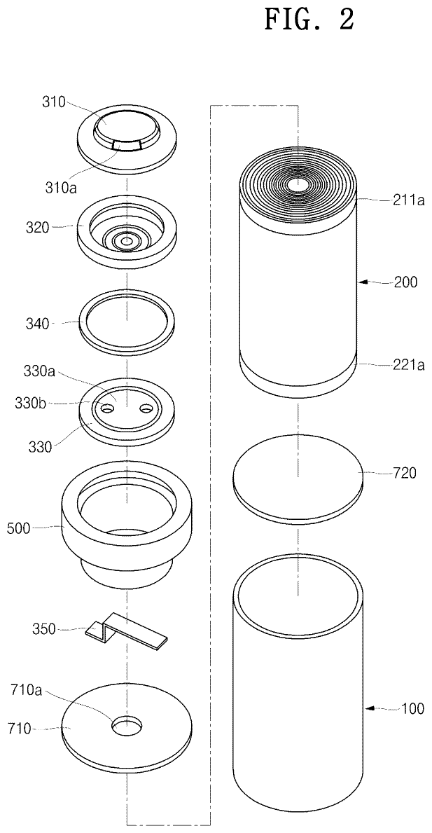

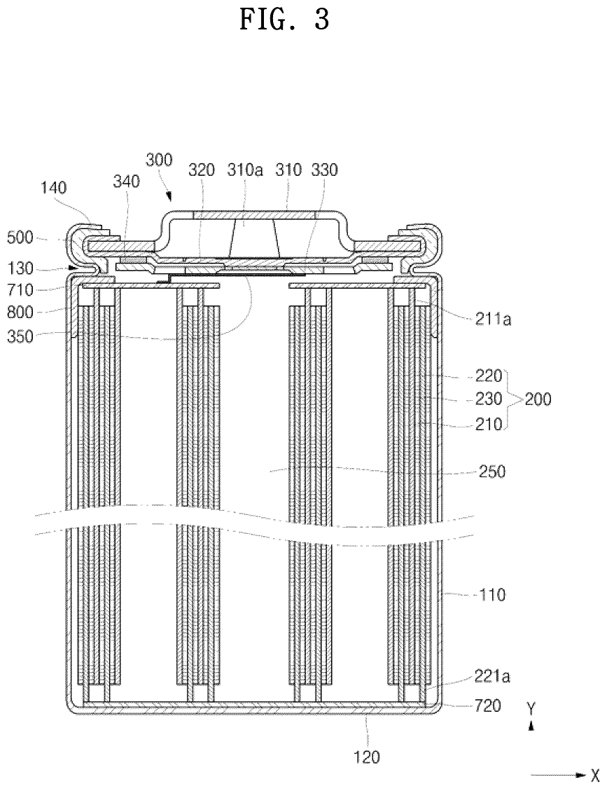

Referring to FIGS. 1 to 3, a secondary battery 1000 may include a case 100, an electrode assembly 200, a lead tab 350, a cap assembly 300, an insulating gasket 500, and current collector plates 710 and 720.

The case 100 forms the outer appearance of the secondary battery 1000. The case 100 may include a conductive metal such as aluminum, an aluminum alloy, or nickel-plated steel. The case 100 may include a space in which the electrode assembly 200 is accommodated. For example, the case 100 includes an accommodation part, and the electrode assembly 200 may be accommodated in the accommodation part. The case 100 may be formed in various shapes. For example, the case 100 may be formed in a circular shape, a prismatic shape, or a pouch shape. However, embodiments of the present disclosure are not limited to such shapes. For convenience, hereinafter a circular-shaped case 100 will be described.

The electrode assembly 200 may include a separator 230, a first electrode 210 and a second electrode 220. The separator 230 may dispose between the first electrode 210 and the second electrode 220. The electrode assembly 200 may be wound into a jelly-roll form. The electrode assembly 200 may be disposed in the accommodation part of the case.

The first electrode 210 includes a first substrate 211 and a first active material layer 212 disposed on the first substrate 211. The first substrate 211 includes a first surface and a second surface opposite to the first surface. The first active material layer 212 may be disposed on at least one of the first and second surfaces of the first substrate 211. The first substrate 211 may include a first uncoated portion 211a where the first active material layer 212 is not provided. That is, the first uncoated portion 211a is a region where the first active material layer 211 is not disposed.

The second electrode 210 includes a second substrate 221 and a second active material layer 222 disposed on the second substrate 221. The second substrate 221 includes a first surface and a second surface opposite to the first surface. The second active material layer 222 may be disposed on at least one of the first and second surfaces of the second substrate 221. The second substrate 221 may include a second uncoated portion 221a where the second active material layer 222 is not provided. That is, the second uncoated portion 221a is a region where the second active material layer 221 is not disposed.

The first electrode 210 may act as a positive electrode. In such an embodiment, the first substrate 211 may be made of, for example, an aluminum foil, and the first active material layer 212 may include, for example, a transition metal oxide. The second electrode 220 may act as a negative electrode. In such an embodiment, the second substrate 221 may be made of, for example, a copper foil or a nickel foil, and the second active material layer 222 may include graphite, for example.

The separator 230 prevents a short circuit between the first electrode 210 and the second electrode 220 while allowing movement of lithium ions therebetween. The separator 230 may be made of, for example, a polyethylene film, a polypropylene film, a polyethylene-polypropylene film, or the like.

The case 100 accommodates the electrode assembly 200 and electrolyte and, together with the cap assembly 300, forms the external appearance of the secondary battery. The case 100 may have a substantially cylindrical body portion 110 and a bottom portion 120 connected to one side (e.g., to one end) of the body portion 110. A beading part 130 (e.g., a bead) deformed inwardly may be formed in the body portion 110, and a crimping part 140 (e.g., a crimp) bent inwardly may be formed at an open end of the body portion 110.

The beading part 130 can reduce or prevent movement of the electrode assembly 200 inside the case 100 and can facilitate seating of the insulating gasket 500 and the cap assembly 300. The crimping part 140 may firmly fix the cap assembly 300 by pressing the edge of the case against the insulating gasket 500.

The cap assembly 300 may be fixed to the inside of the crimping part 140 by the insulating gasket 500 to seal the case 100. The cap assembly 300 may include a cap up (upper cap) 310, a safety vent 320, a cap down (lower cap) 330, and an insulating member 340, but is not limited thereto and may be modified in various ways.

The cap up (upper cap) 310 may be positioned at the uppermost part of the cap assembly 300. The cap up (upper cap) 310 may include a terminal part that protrudes upwardly and is connected to an external circuit, and an outlet 310a for discharging gas may be arranged around the terminal part.

The safety vent 320 may be located under the cap up (upper cap) 310. The safety vent 320 may include a protrusion part that protrudes convexly downwardly and is connected to the cap down (lower cap) 330, and at least one notch may be formed in the protrusion part around the protrusion part.

When gas is generated due to overcharging or abnormal operation of the secondary battery, the protrusion part is deformed upwardly by the pressure and separates from the cap down (lower cap) 330 while the safety vent 320 is cut (e.g., bursts or tears) along the notch. The cut safety vent 320 may prevent the secondary battery from exploding by allowing for the gas to be discharged to the outside.

The cap down (lower cap) 330 may be below the safety vent 320. The cap down (lower cap) 330 may have a first opening 330a for exposing the protrusion part of the safety vent 320 and a second opening 330b for gas discharge. The insulating member 340 may be positioned between the safety vent 320 and the cap down (lower cap) 330 to insulate the safety vent 320 and the cap down (lower cap) 330

The first electrode 210 and the second electrode 220 generate lithium ions through an electrochemical reaction. The electrolyte enables lithium ions to move in the electrode assembly 200. The electrolyte may be a non-aqueous organic electrolyte that is a mixture of a lithium salt and a high purity organic solvent. In other cases, the electrolyte may be a polymer using a polymer electrolyte or a solid electrolyte.

The electrode assembly 200 may include a core part 250. In detail, the electrode assembly 200 is wound, with the core part 250 being formed in the center of the electrode assembly. The electrolyte may easily be injected into the core part 250. When gas or heat is generated in the secondary battery, the gas or heat may easily move to outside of the secondary battery through the core part 250. The separator 230 may be disposed on an inner surface of the core part 250.

Current collector plates are disposed on the upper and lower portions of the electrode assembly 200. The current collector plates include a first current collector plate 710 and a second current collector plate 720. The first current collector plate 710 may be disposed on the electrode assembly 200 between the electrode assembly 200 and the cap assembly 300. The second current collector plate 720 may be disposed under the electrode assembly 200. In detail, the second current collector plate 720 may be disposed between the electrode assembly 200 and the bottom portion 120 of the case.

An area of the first current collector plate 710 may be less than or equal to an area of an upper surface of the electrode assembly. Similarly, an area of the second current collector plate 720 may be less than or equal to an area of a lower surface of the electrode assembly.

The first current collector plate 710 is connected to the first electrode 210. Specifically, the first current collector plate 710 is electrically connected to the first uncoated portion 211a. For example, the first current collector plate 710 and the first uncoated portion 211a may be coupled to each other by welding.

The first current collector plate 710 may be connected to the cap assembly 300. Specifically, a lead tab 350 may be disposed between the first current collector plate 710 and the cap assembly 300. One end of the lead tab 350 may be coupled to the first current collector plate 710 by welding. The other end of the lead tab 350 may be coupled to the cap down (lower cap) 330 by welding. Thus, the first current collector plate 710 and the cap assembly 300 may be electrically connected to each other by the lead tab 350. The first current collector plate 710 thereby forms a passage for a current flow between the first electrode 210 and the cap assembly 300. In such a configuration, the terminal part of the cap assembly may become a positive electrode.

The second current collector plate 720 is connected to the second electrode 220. Specifically, the second current collector plate 720 is electrically connected to the second uncoated portion 221a, for example, by welding. The second current collector plate 720 is also connected to the bottom portion 120 of the case. For example, the second current collector plate 720 and the bottom portion 120 of the case may be coupled to each other by welding. Thus, the second current collector plate 720 may form a passage for a current flow between the second electrode 220 and the case 110. In such a configuration, the case may become a negative electrode.

The first current collector plate 710 may include at least one hole. For example, the first current collector plate 710 may include a first hole 710a. The first hole 710a may correspond to the core part 250. In detail, the first hole 710a and the core part 250 overlap in the Y direction. The electrolyte may move into the electrode assembly 200 through the first hole 710a.

As described above, the first uncoated portion 211a may be coupled to the first current collector plate 710. And, the second uncoated portion 221a may be coupled to the second current collector plate 720. Conventionally, uncoated parts are notched to form a plurality of unit uncoated portions (tabs). Subsequently, after an uncoated portion is bent, the uncoated portion and one of the current collector plates are coupled. Since a separate process for coupling the uncoated portion and the current collector plate is required, the manufacturing process efficiency is reduced. And there is also a problem that the uncoated portion is damaged during the process of bending the uncoated portion. Also, the uncoated portion is required to have a set size in order to be bent. This may cause a problem in that the area of the active material layer is reduced, and, thus, the capacity of the secondary battery is reduced. When the uncoated portion is welded without bending, the active material layer adjacent to the uncoated portion may be damaged by heat from the welding.

An embodiment of the present disclosure may be such that the uncoated portion and the current collector plate are coupled without the notching and bending processes. When the uncoated portion and the current collector plate are coupled, it is possible to prevent the active material layer from being damaged.

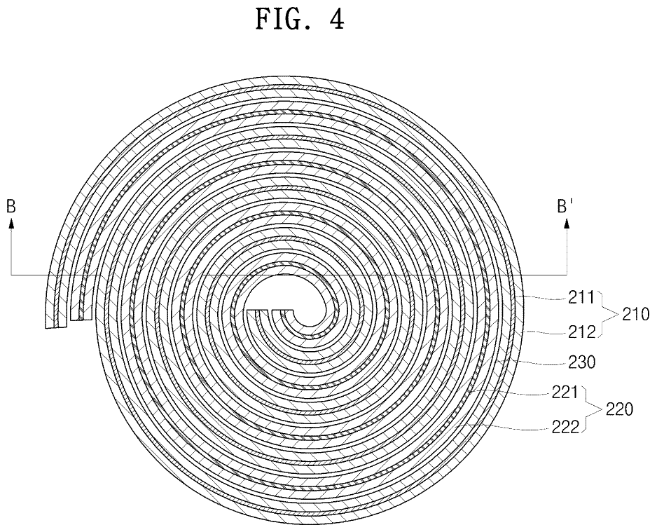

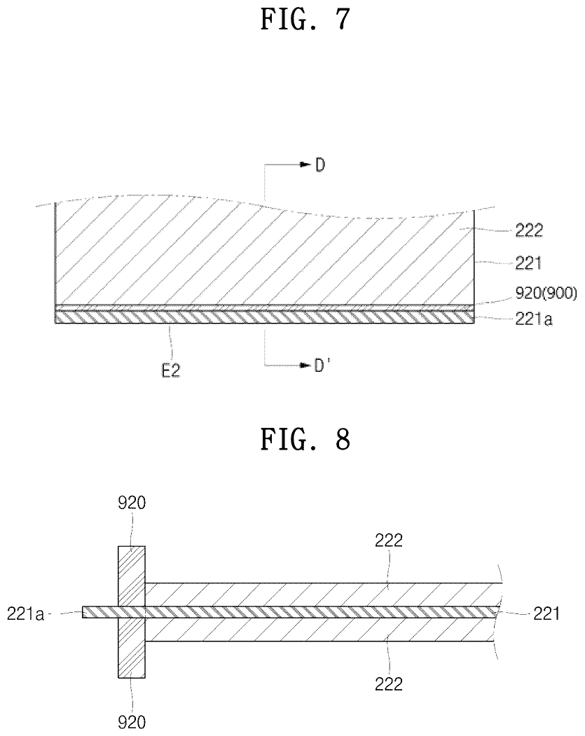

Referring to FIGS. 4 to 9, the secondary battery may include a protective layer 900.

FIG. 4 is a top view showing the electrode assembly. For convenience, the protection layer 900 is omitted in FIG. 4. Referring to FIG. 4, the first electrode 210, the second electrode 220, and the separator 230 may be wound. The first current collector plate 710 may be coupled to the first electrode 210, with the first uncoated portion 211a protruding upward. The first current collector plate 710 and the first uncoated portion 211a may be coupled to each other by welding. And the second current collector plate 720 may be coupled to the second electrode 220, with the second uncoated portion 221a protruding downward. The second current collector plate 720 and the second uncoated portion 221a may be coupled to each other by welding.

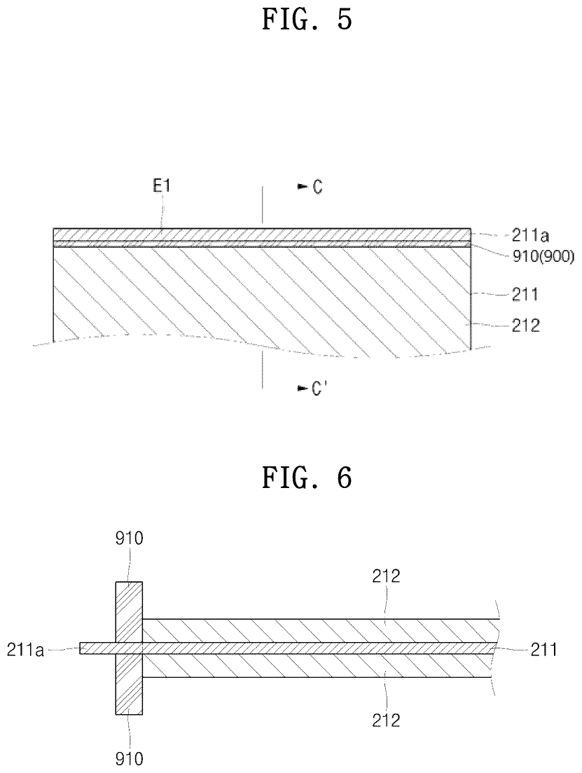

Referring to FIGS. 5 to 8, the uncoated portion is not notched. For example, the first uncoated portion 211a and the second uncoated portion 221a are not divided into a plurality of unit uncoated portions.

The first uncoated portion 211a may extend in the length direction of the first substrate 211. The length of the first uncoated portion 211a may correspond to the length of the first substrate 211. Similarly, the second uncoated portion 221a may extend in the length direction of the second substrate 221. As such, the length of the second uncoated portion 221a may correspond to the length of the second substrate 221.

The protective layer 900 may be disposed on each of the uncoated portions. In an example, the protective layer may include a first protective layer 910 and a second protective layer 920. The first protective layer 910 may be disposed on the first uncoated portion 211a, and the second protective layer 920 may be disposed on the second uncoated portion 221a. Each of the first uncoated portion 211a and the second uncoated portion 221a may include first and second surfaces that are opposite to each other. The protective layer 900 may be disposed on at least one of the one surface or the other surface. For example, the protective layer 900 may be disposed on the one surface and the other surface.

The first protective layer 910 may be disposed adjacent to the first active material layer 212. For example, the first protective layer 910 may be in contact with the first active material layer 212. But, in another embodiment, the first protective layer 910 may be spaced apart from the first active material layer 212. The second protective layer 920 may be disposed adjacent to the second active material layer 222. For example, the second protective layer 920 may be in contact with the second active material layer 222. But in another embodiment, the second protective layer 920 may be spaced apart from the second active material layer 222. When the protective layer(s) 900 contacts the active material layer(s), the area of the protective layer 900 may be increased. When the protective layer(s) 900 is spaced apart from the active material layer(s), the protective layer 900 and the active material layer do not overlap. Accordingly, it is possible to prevent the capacity of the secondary battery from being reduced by the protective layer 900.

The protective layer 900 may have a set thickness. For example, the thickness of the first protective layer 910 may be greater than or equal to the thickness of the first active material layer 212. More specifically, the thickness of the first protective layer 910 may be greater than the thickness of the first active material layer 212. As another example, the thickness of the first protective layer 910 may be less than or equal to the sum of the thicknesses of the first active material layer 212, the second active material layer 222, and the separator 230.

The thickness of the second protective layer 920 may be greater than or equal to the thickness of the second active material layer 222. More specifically, the thickness of the second protective layer 920 may be greater than the thickness of the second active material layer 222. As another example, the thickness of the second protective layer 920 may be less than or equal to the sum of the thicknesses of the first active material layer 212, the second active material layer 222, and the separator 230.

The thicknesses of the first protective layer 910 and the second protective layer 920 may be the same or different within the above-described ranges.

When the electrode assembly 200 is wound, the protective layer 900 is wound. As such, the protective layer 900 may include a flexible material. Accordingly, the protective layer 900 may be easily wound, and the protective layer 900 is not damaged by stress after winding. The protective layer 900 may include a non-conductive material. Thus, even when the first protective layer 910 contacts the second substrate 221 or the second protective layer 920 contacts the first substrate 211, the first electrode and the second electrode are not electrically connected. The configuration thereby prevents the first electrode 210 and the second electrode 220 from being short-circuited by the protective layer 900.

The protective layer 900 may include a magnetic material. For example, the protective layer 900 may include a magnet. Accordingly, the protective layer 900 may be easily disposed on the substrate without a separate coupling process. Further, since the adhesion between the substrate and the protective layer is improved, the protective layer may not be separated in the event of an external impact to the battery.

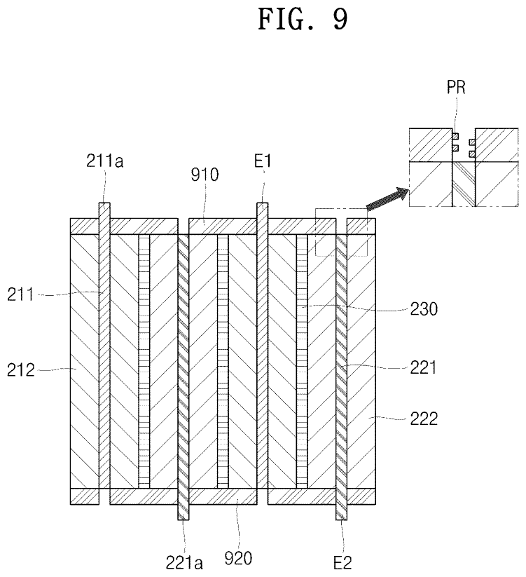

Referring to FIG. 9, after the electrode assembly 200 is wound, the first protective layer 910 may be disposed on (above) the electrode assembly and the second protective layer 920 may be disposed under the electrode assembly. In particular, the first protective layer 910 may be disposed on the first active material layer 212, the second active material layer 222, and the separator 230. In a more specific example, the first protective layer 910 may be disposed to completely cover the first active material layer 212. In another specific example, the first protective layer 910 may be disposed on at least one of the second active material layer 222 or the separator 230. Also, the first protective layer 910 may be disposed to cover the whole or part of the second active material layer 222 and the separator 230. The first protective layer 910 may be in contact with or be spaced apart from the first active material layer 212, the second active material layer 222, and the separator 230.

The second protective layer 920 may be disposed on the first active material layer 212, the second active material layer 222, and the separator 230. In a specific example, the second protective layer 920 may be disposed to completely cover the second active material layer 222. In another specific example, the second protective layer 920 may be disposed on at least one of the first active material layer 212 or the separator 230. The second protective layer 920 may be disposed to cover the whole or part of the first active material layer 212 and the separator 230. The second protective layer 920 may be in contact with or be spaced apart from the first active material layer 212, the second active material layer 222, and the separator 230.

The first current collector plate 710 may be coupled to the end E1 of the first uncoated portion. For example, the end E1 of the first uncoated portion and the first current collector plate 710 may be welded to each other. The second current collector plate 720 may be coupled to the end E2 of the second uncoated portion. For example, the end E2 of the second uncoated portion and the second current collector plate 720 may be welded to each other.

When welding the uncoated portions and the current collector plates, heat and foreign substances may be generated. The first active material layer 212 and the second active material layer 222 may be damaged or deformed by the heat, and the foreign substances may be adsorbed to the first active material layer 212 and the second active material layer 222. Accordingly, the characteristics of the active material layers may be reduced, thereby reducing the capacity of the secondary battery. Further, the separator 230 may be contracted by the heat. In such a case, the first electrode 210 and the second electrode 220 may be short-circuited. But in embodiments of the present disclosure, the first active material layer 212, the second active material layer 222, and the separator 230 may be protected by the protective layer 900. In detail, the heat may be blocked by the protective layer. Therefore, the heat may be prevented or reduced from moving to the active material layer or the separator. Thus, the first active material layer 212, the second active material layer 222, and the separator 230 may not be damaged or contracted during the welding.

The uncoated portion and the current collector plate may be easily coupled without applying a notching and/or bending process to the uncoated portion. Therefore, the secondary battery may be easily manufactured. And the active material layer and the separator may be prevented from being deformed by the heat generated during the welding. The secondary battery therefore has improved reliability. And, since the process of bending the uncoated portion is not required, the size of the uncoated portion may be reduced. Accordingly, the area of the active material layer may be increased. As a result, the secondary battery according to the embodiment may have improved capacity.

At least one of the first protective layer 910 or the second protective layer 920 may include a protrusion PR. The protrusion PR may be disposed on an upper surface of the protective layer. And after the electrode assembly is wound, the protrusion PR may be disposed on the substrate. For example, the protrusion of the first protective layer may be disposed on the second substrate 221. Or the protrusion of the second protective layer may be disposed on the first substrate 211. Foreign substances generated when welding the current collector plate may be blocked by the protrusion(s). That is, foreign substances may be prevented or reduced from moving to the substrate by the protrusion(s). Thus, the performance of the secondary battery may not be reduced by foreign substances.

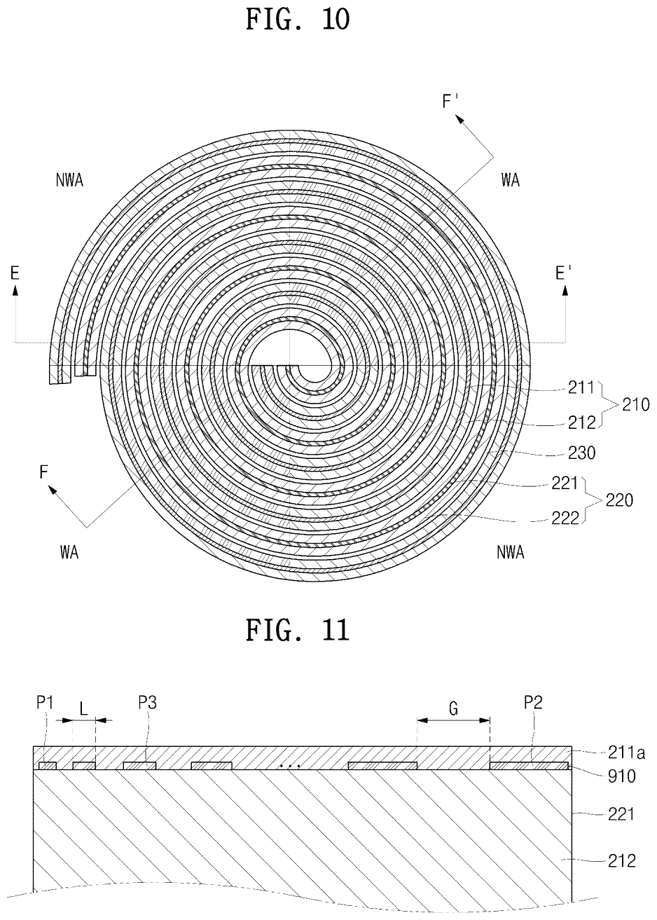

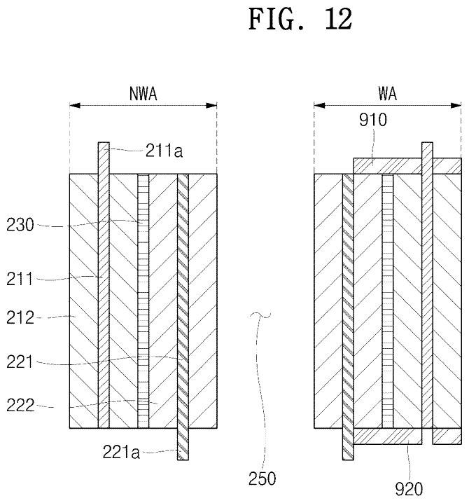

Hereinafter, the secondary battery according to another embodiment will be described with reference to FIGS. 10 to 13. In the following description, the descriptions of features that are the same as in the above-described embodiment will be omitted.

Referring to FIGS. 10 to 12, the electrode assembly may be divided into a plurality of regions. For example, the electrode assembly may be divided into a welding region WA and a non-welding region NWA. FIGS. 10 and 11 illustrate the first electrode. However, the following description also applies to the second electrode. For convenience, the protective layer is omitted from the depiction shown in FIG. 10.

The welding region WA is a region in which the first current collector plate 710 and the first electrode 210 are coupled to each other. The non-welding region NWA is a region in which the first current collector plate 710 and the first electrode 210 are not coupled to each other. In embodiments, the first protective layer 910 may be disposed on the welding region WA, and the first protective layer 910 may not be disposed on the non-welding region NWA. The first protective layer 910 may include a plurality of patterns spaced apart from each other. In some embodiments, the first protective layer 910 may be disposed only at a set position.

Referring to FIG. 11, the first protective layer 910 may include a first pattern P1, a second pattern P2, and a third pattern P3. The first pattern P1 may be adjacent to an end of the electrode assembly from which the electrode assembly is wound. The second pattern P2 may be adjacent to an end of the electrode assembly where the winding ends. The third pattern P3 may be disposed between the first pattern P1 and the second pattern P2. The patterns may have different sizes and intervals (i.e., distances between each of the patterns). For example, the length L of the patterns may increase in a direction from the winding start end to the winding ending end. And, the interval G of the patterns may increase from the winding start end to the winding ending end. That is, the length of the first pattern P1 may be less than the length of the second pattern P2. And, the interval of the first pattern P1 may be less than the interval of the second pattern P2. The length of one turn of the electrode assembly increases from the winding center to the winding ending end. Accordingly, the positions of the welding region WA and the non-welding region NWA may be controlled by the length and interval of the patterns. That is, the welding regions WA may face each other and be disposed symmetrically.

The secondary battery according to another embodiment may include the protective layer. The protective layer may be disposed at a set position. For example, the protective layer may be disposed in a partial region of the substrate. Accordingly, the area in which the active material layer is disposed may be increased, and the capacity of the secondary battery may thereby be improved.

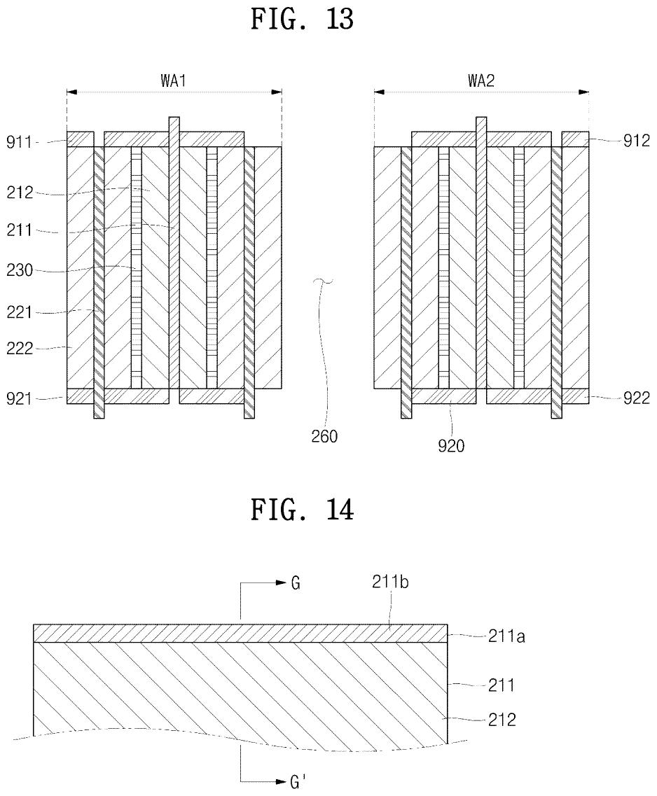

The protective layer may have a plurality of polarities. Referring to FIG. 13, the electrode assembly may include a first welding region WA1 and a second welding region WA2. The first-first protective layer 911 and the second-first protective layer 921 may be disposed in the first welding region WA1. In particular, the first-first protective layer 911 may be disposed in an upper portion of the electrode assembly, and the second-first protective layer 921 may be disposed in a lower portion of the electrode assembly. The first-second protective layer 912 and the second-second protective layer 922 may be disposed in the second welding region WA2. In particular, the first-second protective layer 912 may be disposed in the upper portion of the electrode assembly, and the second-second protective layer 922 may be disposed in the lower portion of the electrode assembly. The first-first protective layer 911, the first-second protective layer 912, the second-first protective layer 921, and the second-second protective layer 922 may include a magnetic material. For example, the first-first protective layer 911, the first-second protective layer 912, the second-first protective layer 921, and the second-second protective layer 922 may include a magnet. At least one of the first-first protective layer 911, the first-second protective layer 912, the second-first protective layer 921, or the second-second protective layer 922 may have different polarities. For example, the first-first protective layer 911 and the first-second protective layer 912 may have different polarities. And the second-first protective layer 921 and the second-second protective layer 922 may have different polarities. The difference in polarities of the protective layer may be realized by disposing different polarities in the protective layer. Thus, magnetic attraction may occur between the first welding region WA1 and the second welding region WA2, which prevents or reduces unwinding of the electrode assembly. Thus, winding characteristics of the secondary battery may be improved.

In other embodiments, the first-first protective layer 911 and the second-first protective layer 921 may have the same polarity. And the first-second protective layer 912 and the second-second protective layer 922 may have the same polarity. In such a configuration, repulsive force may be generated between upper and lower portions of the electrode assembly. It is therefore possible to prevent or reduce damage of the active material layer by pressure of the protective layer. Thus, reliability and capacity of the secondary battery may be improved.

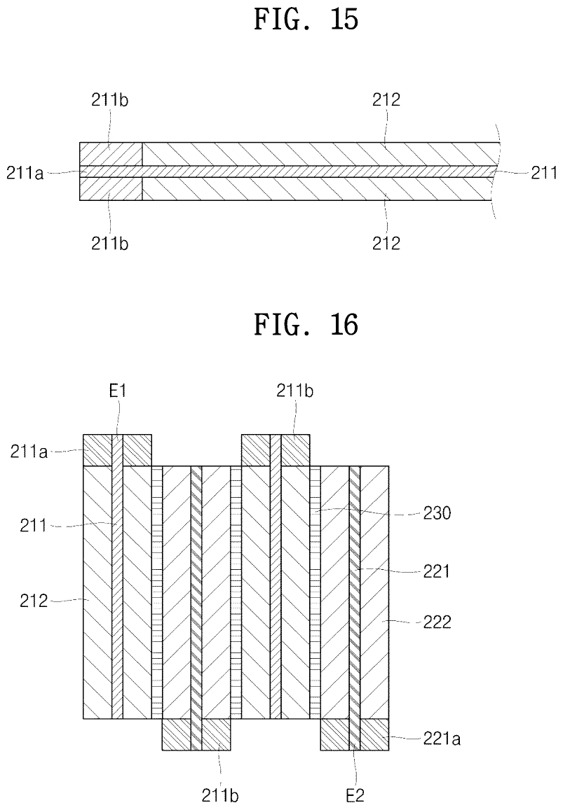

Hereinafter, the secondary battery according to another embodiment will be described with reference to FIGS. 14 to 16. In the following description, the descriptions of features that are the same as in the above-described embodiment will be omitted.

Referring to FIGS. 14 to 16, the secondary battery may include a reinforcing part. The reinforcing part may include a first reinforcing part 211b and a second reinforcing part 221b. The first reinforcing part 211b may be disposed on the first uncoated portion 211a, and the second reinforcing part 221b may be disposed on the second uncoated portion 221a.

The reinforcing part may include a conductive material. For example, the reinforcing part may include a metal. The first reinforcing part 211b may include the same material as the first substrate 211. In a particular example, the first reinforcing part 211b includes aluminum. The first reinforcing part 211b may be integrally formed with the first substrate 211. The first reinforcing part 211b may be disposed on the entire region of the first uncoated part 211a. The first reinforcing part 211b may have a set thickness. And the thickness of the first reinforcing part 211b may be similar to the thickness of the first active material layer 212. The length of the first reinforcing part 211b may be similar to the length of the first uncoated portion 211a. For example, the length of the first reinforcing part 211 b may be 95% to 105% of the length of the first uncoated portion 211a. When the length of the first reinforcing part 211b is outside of this range, the welding characteristics of the first current collector plate may be reduced by the step that is formed between the first reinforcing part and the first uncoated portion.

The second reinforcing part 221b may include the same material as the second substrate 221. For example, the second reinforcing part 221b may include copper. The second reinforcing part 221b may be integrally formed with the second substrate 221. The second reinforcing part 221b may be disposed on the entire region of the second uncoated portion 221a. The second reinforcing part 221b may have a set thickness, and the thickness of the second reinforcing part 221b may be similar to the thickness of the second active material layer 222. The length of the second reinforcing part 221b may be similar to the length of the second uncoated portion 221a. For example, the length of the second reinforcing part 221 b may be 95% to 105% of the length of the second uncoated portion 221a. When the length of the second reinforcing part 221b is outside of this range, the welding characteristics of the second current collector plate may be reduced due to the step that is formed between the second reinforcing part and the second uncoated portion.

The reinforcing part may be coupled to the current collector plate. For example, the first current collector plate 710 may be welded to the end E1 of the first uncoated portion and the first reinforcing part 211b. Similarly, the second current collector plate 720 may be welded to the end E2 of the second uncoated portion and the second reinforcing part 221b.

When the current collector plate is welded only to the end of the uncoated portion, the welding area may be reduced. Thus, a coupling force between the current collector plate and the electrode may be reduced. Embodiments of the present may solve the such problems. In detail, the welding area of the current collector plate may be increased by the reinforcing part. Thus, the coupling force between the current collector plate and the electrode may be increased. And the welding area of the current collector plate may be secured by welding only a part of the uncoated portions. Thus, a manufacturing process efficiency of the secondary battery may be improved.

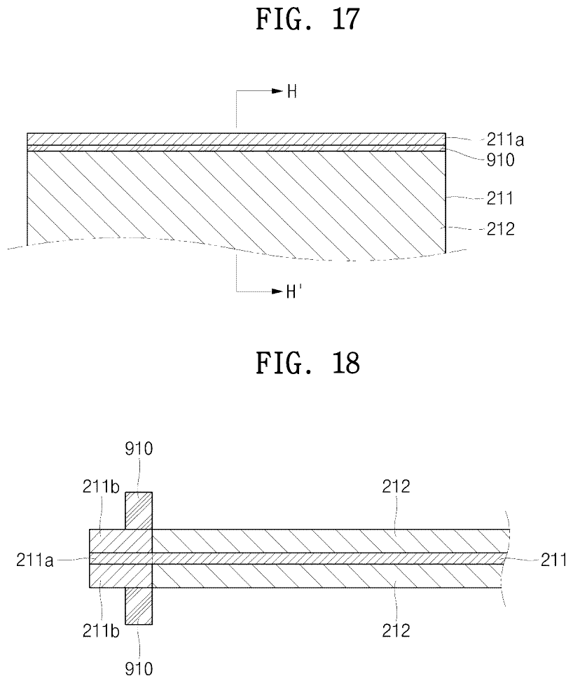

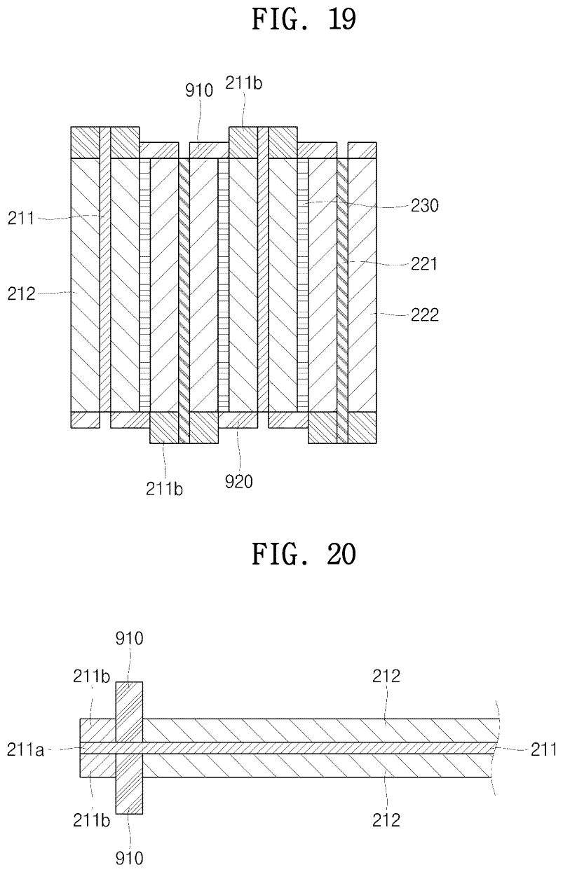

Hereinafter, the secondary battery according to another embodiment will be described with reference to FIGS. 17 to 21. In the following description, the descriptions of features that are the same as in the above-described embodiment will be omitted.

Referring to FIGS. 17 to 19, the secondary battery may include the protective layer and the reinforcing part. The reinforcing part may include the first reinforcing part 211b and the second reinforcing part 221b. The first reinforcing part 211b may be disposed on the first uncoated portion 211a. The second reinforcing part 221b may be disposed on the second uncoated portion 221a. Since the first reinforcing part 211b and the second reinforcing part 221b are the same as the previously described reinforcing parts, further descriptions of these structures will be omitted.

The protective layer may be disposed on the reinforcing part. For example, the first protective layer 910 may be disposed on the first reinforcing part 211b. In particular, the first protective layer 910 may be disposed on a partial region of the first reinforcing part. And, the second protective layer 920 may be disposed on the second reinforcing part 221b. In particular, the second protective layer 910 may be disposed on a partial region of the second reinforcing part.

After winding the electrode assembly, the first protective layer 910 may be disposed on at least one of the second active material layer 222 or the separator 230. And the first protective layer 910 may be disposed on at least one of the first active material layer 212 or the separator 230.

The secondary battery according to this embodiment includes the reinforcing part. The welding area of the current collector plate may be increased by the reinforcing part. Thus, the coupling force between the current collector plate and the electrode may be increased. And the welding area of the current collector plate may be secured by welding only a part of the uncoated portions. Thus, the manufacturing process efficiency of the secondary battery may be improved.

Further, the secondary battery according to this embodiment includes the protective layer. The protective layer may be disposed on the second active material layer 222 and/or the separator 230 at an upper portion of the electrode assembly. And the protective layer may be disposed on the first active material layer 212 and/or the separator 230 at a lower portion of the electrode assembly.

When welding the current collector plate, heat and foreign substances may be generated. The heat and foreign substances may be blocked by the protective layer. Thus, heat or foreign substances may be prevented from being transferred from the upper portion of the electrode assembly to the second active material layer and the separator. And heat or foreign substances may be prevented from being transferred from the lower portion of the electrode assembly to the first active material layer and the separator. Thus, the secondary battery according to the embodiment may have improved reliability and capacity.

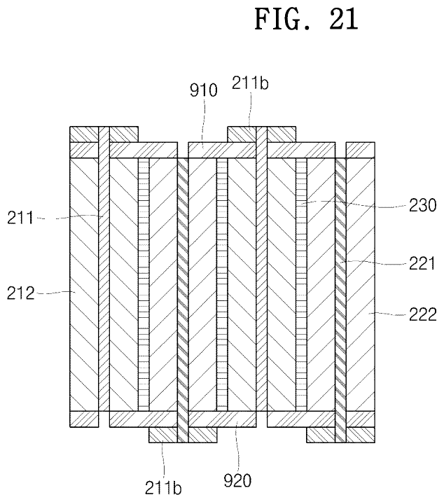

Referring to FIGS. 20 and 21, the protective layer and the reinforcing part may be disposed on the uncoated portion. For example, the first protective layer 910 and the first reinforcing part 211b may be disposed on the same surface of the first uncoated portion 211a. Similarly, the second protective layer 920 and the second reinforcing part 221b may be disposed on the same surface of the second uncoated portion 221a.

The lengths of the protective layer and the reinforcing part may be the same or similar. And, the thicknesses of the protective layer and the reinforcing part may be different. For example, the thickness of the protective layer may be greater than that of the reinforcing part. Accordingly, the protective layer may protect adjacent active material layers and separators.

The protective layer is disposed between the reinforcing part and the active material layer. Accordingly, heat generated when the current collector plate and the reinforcing part are welded may be prevented or reduced from being transferred to the active material, and damage to the active material layer may thereby be prevented. Accordingly, the secondary battery according to the embodiment may have improved reliability and capacity.

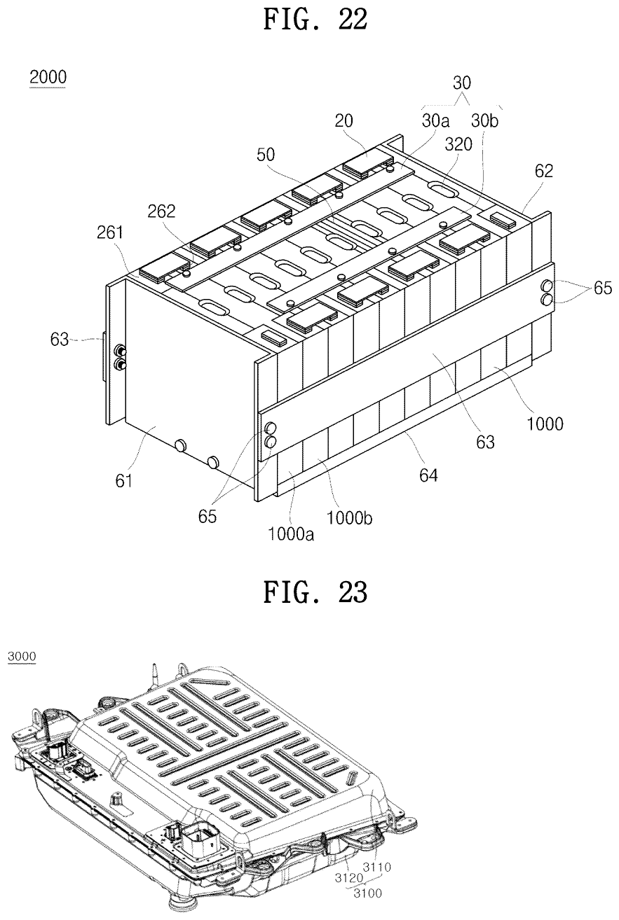

Hereinafter, a battery module including secondary batteries according to embodiments will be described with reference to FIG. 22.

Referring to FIG. 22, the battery module 2000 according to one or more example embodiments of the present disclosure includes terminal parts 261 and 262, a plurality of secondary battery 1000 arranged in one direction, a connection tab 20 connecting a secondary battery 1000a to an adjacent secondary battery 1000b, and a protection circuit module 30 having one end connected to the connection tab 20. The protection circuit module 30 may include a battery management system (BMS). Further, the connection tab 20 may include a body portion in contact with the terminal parts 261 and 262 between the adjacent secondary battery 1000a and 1000b and an extension portion extending from the body portion and connected to the protection circuit module 30. The connection tab 20 may be, for example, a bus bar.

Each secondary battery 1000 may include a battery case, an electrode assembly received (or accommodated) in the battery case, and an electrolyte. The electrode assembly and the electrolyte react electrochemically to store and release (e.g., generate) energy. Terminal parts 261 and 262 electrically connected to the connection tab 20 and a vent 850 as a discharge passage for gas generated inside the battery case may be provided on one side of (e.g., an upper side of) the secondary battery 1000. The terminal parts 261 and 262 of the secondary battery 1000 may be a positive electrode terminal 261 and a negative electrode terminal 262 having different polarities from each other, and the terminal parts 261 and 262 of the adjacent secondary battery 1000a and 1000b may be electrically connected to each other in series or parallel by the connection tab 20, to be described in more detail below. Although a serial connection has been described as an example, the connection structure is not limited thereto, and various connection structures may be employed as desired or necessary. In addition, the number and arrangement of secondary battery is not limited to the structure shown in FIG. 22 and may be changed as desired or necessary.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary battery batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 34 interposed therebetween but may be disposed parallel to the first protection circuit module 30a. As such, the two protection circuit modules are spaced from each other side-by-side along the direction in which the plurality of secondary batteries 1000 are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electric wire. In addition, the connection member 50 may be made of or include a material having elasticity or flexibility. By the connecting member 50, it may be possible to check and manage whether the voltage, temperature, and/or current of the plurality of secondary battery 1000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells, shocks may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 22.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

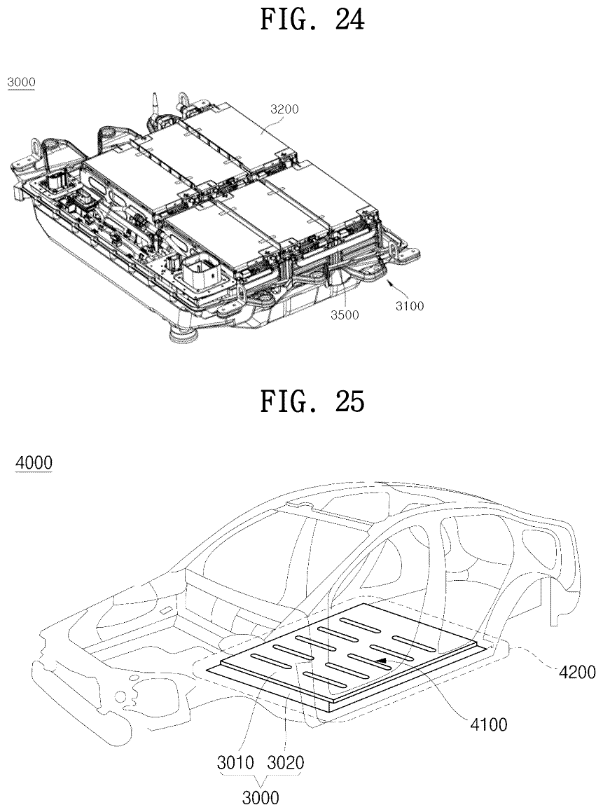

FIGS. 23 and 24 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 25, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

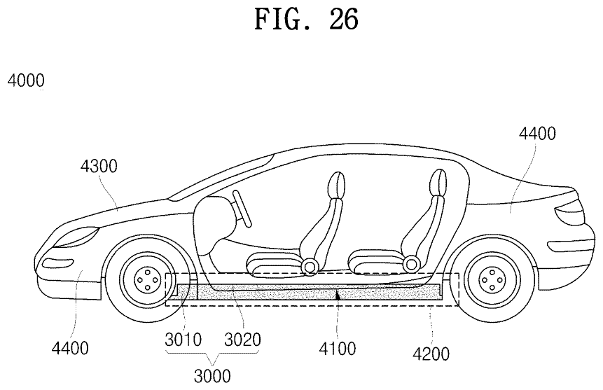

In FIG. 26, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. An electrode assembly comprising:
a first electrode comprising:
a first substrate including a first uncoated portion extending upwardly,
a first active material layer on the first substrate, and
a first protective layer on the first uncoated portion of the first substrate;
a second electrode comprising
a second substrate including a second uncoated portion extending downwardly,
a second active material layer on the second substrate, and
a second protective layer on the second uncoated portion; and
a separator between the first electrode and the second electrode,
wherein the first protective layer and the second protective layer are disposed at least one on the first active material layer, the second active material layer, or the separator.

2. The electrode assembly as claimed in claim 1, wherein the first protective layer covers an entirety of the first active material layer,
wherein the second protective layer covers an entirety of the second active material layer.

3. The electrode assembly as claimed in claim 1, wherein the first protective layer is spaced apart from the first active material layer, and the second protective layer is spaced apart from the second active material layer.

4. The electrode assembly as claimed in claim 1, wherein the first protective layer is in contact with the first active material layer, and the second protective layer is in contact with the second active material layer.

5. The electrode assembly as claimed in claim 1, wherein a thicknesses of the first protective layer and a thickness of the second protective layer are less than or equal to the sum of the thicknesses of the first active material layer, the second active material layer, and the separator.

6. The electrode assembly as claimed in claim 1, wherein the first protective layer and the second protective layer comprise a non-conductive material.

7. The electrode assembly as claimed in claim 1, wherein the first protective layer and the second protective layer comprise a magnetic material.

8. The electrode assembly as claimed in claim 1, wherein the first protective layer and the second protective layer comprise a plurality of patterns spaced apart from each other,
wherein the electrode assembly is wound, and
wherein a length and an interval of the patterns increase from a start of the winding of the electrode assembly to an end of the winding of the electrode assembly.

9. The electrode assembly as claimed in claim 8, wherein the electrode assembly comprises a welding region and a non-welding region, and
wherein the patterns are disposed in the welding region.

10. The electrode assembly as claimed in claim 9, wherein the welding region comprises a first welding region and a second welding region facing each other,
wherein a first-first protective layer and a second-first protective layer are respectively disposed on the upper and lower portions of the first welding region,
wherein a first-second protective layer and a second-second protective layer are respectively disposed on the upper and lower portions of the second welding region, and
wherein at least one of the first-first protective layer, the first-second protective layer, the second-first protective layer, or the second-second protective layer has a polarity that is different from another of the first-first protective layer, the first-second protective layer, the second-first protective layer, or the second-second protective layer.

11. The electrode assembly as claimed in claim 10, wherein the first-first protective layer and the first-second protective layer have different polarities, and
wherein the second-first protective layer and the second-second protective layer have different polarities.

12. The electrode assembly as claimed in claim 10, wherein the first-first protective layer and the second-first protective layer have the same polarity, and
wherein the first-second protective layer and the second-second protective layer have the same polarity.

13. The electrode assembly as claimed in claim 1, wherein at least one of the first protective layer or the second protective layer comprises a protrusion.

14. An electrode assembly comprising:
a first electrode comprising:
a first substrate including a first uncoated portion extending upwardly,
a first active material layer on the first substrate, and
a first reinforcing part on the first uncoated portion;
a second electrode comprising:
a second substrate including a second uncoated portion extending downwardly,
a second active material layer on the second substrate, and
a second reinforcing part on the second uncoated portion; and
a separator between the first electrode and the second electrode,
wherein the first reinforcing part and the second reinforcing part are disposed on the first active material layer, the second active material layer, and the separator,
wherein the first reinforcing part and the first substrate are formed from the same material, and
wherein the second reinforcing part and the second substrate are formed from the same material.

15. The electrode assembly as claimed in claim 14, wherein a length of the first reinforcing part is 95% to 105% of a length of the first uncoated portion, and
wherein a length of the second reinforcing part is 95% to 105% of a length of the second uncoated portion.

16. The electrode assembly as claimed in claim 14, further comprising a first protective layer on the first reinforcing part and a second protective layer on the second reinforcing part.

17. The electrode assembly as claimed in claim 16, wherein the first protective layer is disposed on the second active material layer and the separator, and
wherein the second protective layer is disposed on the first active material layer and the separator.

18. The electrode assembly as claimed in claim 16, further comprising a first protective layer on the first uncoated portion and a second protective layer on the second uncoated portion,
wherein the first reinforcing part and the first protective layer are disposed on a surface of the first uncoated portion, and
wherein the second reinforcing part and the second protective layer are disposed on a surface of the second uncoated portion.

19. A secondary battery comprising:
a case;
an electrode assembly according to claim 1 accommodated in the case;
a first current collector plate coupled to the first uncoated portion of the first electrode;
a second collector plate coupled to the second uncoated portion of the second electrode; and
a cap assembly sealing the case.
